(19) United States
(12) Patent Application Publication
(10) Pub. No.: US 2026/0121572 A1
(43) Pub. Date: Apr. 30, 2026

(54) INVERTER CONTROL DEVICE, INVERTER CONTROL METHOD THEREOF, AND VEHICLE INCLUDING SAME

(71) Applicants: HYUNDAI MOTOR COMPANY, SEOUL (KR); KIA CORPORATION, SEOUL (KR)

(72) Inventors: Young Su Ko, Hwaseong-si (KR); Ho Joon Shin, Hwaseong-si (KR); Young Ho Chae, Hwaseong-si (KR); Joo Young Park, Hwaseong-si (KR); Yeong Ju Koh, Hwaseong-si (KR)

(73) Assignees: HYUNDAI MOTOR COMPANY, SEOUL (KR); KIA CORPORATION, SEOUL (KR)

(21) Appl. No.: 19/219,049

(22) Filed: May 27, 2025

(30) Foreign Application Priority Data
Oct. 30, 2024 (KR) 10-2024-0151318

(51) Int. Cl. H02P 29/68; B60L 15/00; H02P 23/03

(52) U.S. Cl. CPC H02P 29/68; B60L 15/007; H02P 23/03; B60L 2240/421; B60L 2240/423

(57) ABSTRACT

An inverter control device is capable of reducing an inverter junction temperature by minimizing a maximum value of a phase current flowing through an inverter. The inverter control device includes a current command output module configured to output a current command corresponding to an input torque command, a current command conversion module configured to receive the current command and a zero sequence current command, and phase-shift the current command to output a phase-shifted current command, a switching determination module configured to output a control signal based on an input motor rotation speed and the torque command, and a switching module configured to selectively output one of the current command and the phase-shifted current command in response to the control signal.

### CROSS-REFERENCE TO THE RELATED APPLICATION

The present application claims the benefit of priority under 35 U.S.C § 119 of Korean Patent Application No. 10-2024-0151318, filed on Oct. 30, 2024 in the Korean Intellectual Property Office, the disclosure of which is incorporated herein by reference in its entirety.

### TECHNICAL FIELD

The present disclosure is related to an inverter control technique, and more specifically, to an inverter control device capable of reducing an inverter junction temperature by minimizing a maximum value of a phase current flowing through an inverter, an inverter control method thereof, and a vehicle including the same.

### BACKGROUND

Maximum Torque Per Ampere (MTPA) control used to drive a permanent magnet synchronous motor (PMSM) is a technique for generating a maximum torque by supplying a minimum three-phase balanced current and can minimize copper loss and increase motor efficiency since it uses the minimum current to generate the same torque.

However, when MTPA control is applied in a situation where the motor continuously outputs torque in a stationary state or an extremely low-speed rotation state (e.g., a hill hold state to prevent rolling without braking on a hill), the current flowing through the motor may be concentrated on one of the three phases depending on the electric angle of the motor, and heat generated in a power module that conducts the current of the phase where the current is concentrated may be significantly higher than the junction temperature of the other phases.

Therefore, a technique capable of reducing the magnitude of the current concentrated on one phase in a hill hold state to decrease overheating occurring in the power module is required.

This background technology is technical information that the inventor possessed for the derivation of the present disclosure or acquired during the present disclosure derivation process, and cannot necessarily be considered as a publicly known technology disclosed to the general public before the application of the present disclosure. The subject matter described in this background section is intended to promote an understanding of the background of the disclosure and thus may include subject matter that is not already known to those of ordinary skill in the art.

### SUMMARY

The present disclosure has been made in view of the above problems, and it is an object of the present disclosure to provide an inverter junction temperature reduction technique capable of alleviating the phenomenon of heat generation being concentrated in a power module of one phase in a hill hold state (including a motor stop state, an extremely low-speed rotation state of the motor, etc.).

It is another object of the present disclosure to provide a Maximum Torque Per Degree (MTPD) control technique capable of generating maximum torque while intentionally flowing a zero sequence current that is avoided during motor control to minimize a maximum value of a phase current.

It is a further object of the present disclosure to provide an inverter junction temperature reduction technique capable of ultimately achieving hardware cost reduction by lowering a junction temperature compared to MTPA at the same torque.

It is a further object of the present disclosure to provide an inverter control device to which the inverter junction temperature reduction technique proposed in the present disclosure is applied, an inverter control method thereof, and a vehicle including the same.

The technical objects of the present disclosure are not limited to the matters mentioned above, and those with ordinary skill in the art to which the present disclosure pertains will be able to clearly understand other objects intended by the present disclosure from the following description.

As technical means for achieving the above-described objects, the present disclosure provides an inverter control device to which an inverter junction temperature reduction technique proposed in the present disclosure is applied, an inverter control method thereof, and a vehicle including the same.

In accordance with an aspect of the present disclosure, the above and other objects can be accomplished by the provision of an inverter control device including a current command output module configured to output a current command corresponding to an input torque command, a current command conversion module configured to receive the current command and a zero sequence current command, and phase-shift the current command to output a phase-shifted current command, a switching determination module configured to output a control signal based on an input motor rotation speed and the torque command, and a switching module configured to selectively output one of the current command and the phase-shifted current command in response to the control signal.

According to an embodiment, an average of a minimum phase value and a maximum phase value of the phase-shifted current command may be 0 A.

According to an embodiment, the current command conversion module may generate a phase current command based on the current command and the zero sequence current command, and shift the phase of the phase current command by an average of a maximum phase value and a minimum phase value of the phase current command to generate a phase-shifted phase current command.

According to an embodiment, the current command conversion module may perform coordinate axis transformation on the phase-shifted phase current command to output the phase-shifted current command.

According to an embodiment, the current command conversion module may include a first coordinate axis transformation module configured to generate a phase current command based on the current command and the zero sequence current command, a minimum/maximum determination module configured to determine a minimum phase value and a maximum phase value based on the phase current command, an average determination module configured to determine an average of the minimum phase value and the maximum phase value, and a phase conversion module configured to convert the phase of the phase current command based on the average of the minimum phase value and the maximum phase value to generate a phase-shifted phase current command.

According to an embodiment, the phase conversion module may shift the phase of the phase current command by the average of the minimum phase value and the maximum phase value.

According to an embodiment, the average of the minimum phase value and the maximum phase value of the phase-shifted phase current command may be 0 A.

According to an embodiment, the switching determination module may include a control mode determination module configured to determine a control mode based on the motor rotation speed and the torque command and output a control mode signal corresponding to the determined control mode, and a control signal output module configured to output the control signal in response to the control mode signal.

According to an embodiment, the control mode determination module may include a control mode table including a first control mode signal or a second control mode signal set according to the motor rotation speed and the torque command.

According to an embodiment, the control mode determination module may output the first control mode signal to cause the switching module to output the current command, and output the second control mode signal to cause the switching module to output the phase-shifted current command.

In accordance with another aspect of the present disclosure, there is provided an inverter control method including outputting a current command corresponding to an input torque command, phase-shifting the current command based on the current command and a zero sequence current command to output a phase-shifted current command, outputting a control signal based on a motor rotation speed and the torque command, and selectively outputting one of the current command and the phase-shifted current command in response to the control signal.

According to an embodiment, the inverter control method may further include outputting a phase voltage command corresponding to the current command or the phase-shifted current command, and modulating the phase voltage command to output a pulse width modulation (PWM) signal to an inverter.

According to an embodiment, the outputting the phase-shifted current command may include generating a phase current command based on the current command and the zero sequence current command, determining a minimum phase value and a maximum phase value based on the phase current command, determining an average of the minimum phase value and the maximum phase value, and generating a phase-shifted phase current command by converting the phase of the phase current command based on the average of the minimum phase value and the maximum phase value.

According to an embodiment, converting the phase of the phase current command may include shifting the phase of the phase current command by the average of the minimum phase value and the maximum phase value.

According to an embodiment, the average of the minimum phase value and the maximum phase value of the phase-shifted phase current command may be 0 A.

According to an embodiment, the outputting the phase-shifted current command may include performing coordinate axis transformation on the phase-shifted phase current command and outputting the phase-shifted current command. According to an embodiment, the outputting a control signal may include determining a control mode based on the motor rotation speed and the torque command, outputting a control mode signal corresponding to the control mode, and outputting the control signal in response to the control mode signal.

According to an embodiment, the outputting a control signal may include outputting a first control mode signal to cause the switching module to output the current command and outputting a second control mode signal to cause the switching module to output the phase-shifted current command.

In accordance with a further aspect of the present disclosure, there is provided a vehicle traveling using a motor as a driving source, the vehicle including an inverter for driving the motor, and a device for controlling the inverter, wherein the device generates a current command corresponding to a torque command, receives the current command and a zero sequence current command, phase-shifts the current command to generate a phase-shifted current command, and selectively outputs one of the current command and the phase-shifted current command based on a motor rotation speed and the torque command.

Specific details according to various examples of the present disclosure other than the means for solving the problems mentioned above are included in the description and drawings below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an example of a motor system including an inverter control device to which an inverter junction temperature reduction technique according to an embodiment of the present disclosure is applied;

FIG. 2 is a diagram showing a configuration of a controller according to an embodiment of the present disclosure;

FIG. 3 is a diagram showing a configuration of a current command conversion module according to an embodiment of the present disclosure;

FIG. 4 is a diagram showing a configuration of a switching determination module and a switching module according to an embodiment of the present disclosure;

FIG. 5 is a diagram illustrating a method of controlling a motor drive inverter according to an embodiment of the present disclosure;

FIG. 6 is a diagram specifically illustrating step S510 of FIG. 5; and

FIG. 7 is a graph for explaining a limit torque depending on whether or not an MTPD control technique according to an embodiment of the present disclosure is applied.

### DETAILED DESCRIPTION

The advantages and features of the present disclosure and the way of attaining the same will become apparent with reference to embodiments described below in detail in conjunction with the accompanying drawings. The present disclosure, however, is not limited to the embodiments disclosed hereinafter and may be embodied in many different forms. Rather, these exemplary embodiments are provided so that this disclosure will be through and complete and will fully convey the scope to those skilled in the art. Thus, the scope of the present disclosure should be defined by the claims.

In the drawings for explaining the exemplary embodiments of the present disclosure, the illustrated shape, size, ratio, angle, and number are given by way of example, and thus, the present disclosure is not limited thereby. Throughout the present specification, the same reference numerals designate the same constituent elements. In addition, in the following description of the present disclosure, a detailed description of known functions and configurations incorporated herein will be omitted when it may make the subject matter of the present disclosure rather unclear. The terms “comprise”, “include” and “have” used in this specification do not preclude the presence or addition of other elements unless it is used along with the term “only”. The singular forms are intended to include the plural forms as well, unless the context clearly indicates otherwise.

In the interpretation of constituent elements, the constituent elements are interpreted as including an error range even if there is no explicit description thereof.

In the description of temporal relationships, when a temporal relationship between two actions is described using “after”, “subsequently”, “next”, “before”, or the like, the actions may not occur in succession unless the term “directly” or “just” is used.

Although terms such as “first” and “second” may be used to describe various elements, these terms are merely used to distinguish the same or similar elements from each other. Therefore, a first element mentioned below may be a second element within the technical scope of the present disclosure.

It will be understood that, although the terms “first”, “second”, A, B, (a), (b), etc. may be used herein to describe elements of the present disclosure, these terms are only used to distinguish one element from another element and necessity, order, or sequence of corresponding elements are not limited by these terms. It will be understood that, when one element is referred to as being “connected to”, “coupled to”, or “access” another element, the one element may be “connected to”, “coupled to”, or “access” another element via a further element although one element may be directly connected to or directly access another element.

“At least one” should be understood to include any combination of one or more of associated elements. For example, “at least one of first, second, and third elements” means not only the first, second, or third element, but also combinations of two or more of the first, second, and third elements.

The respective features of the present disclosure may be partially or wholly coupled to and combined with each other, and various technical linkages are possible. These various embodiments may be performed independently of each other, or may be performed in association with each other.

The scale of elements shown in the drawings is different from the actual scale for convenience of description and is therefore not limited to the scale shown in the drawings. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Hereinafter, an inverter control device, an inverter control method thereof, and a vehicle including the same according to an embodiment of the present disclosure will be described with reference to the attached drawings.

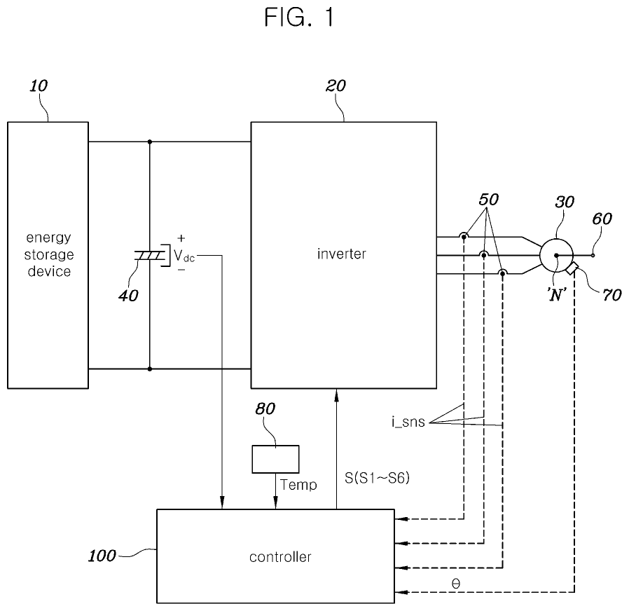

FIG. 1 is a diagram showing an example of a motor system including an inverter control device to which an inverter junction temperature reduction technique according to an embodiment of the present disclosure is applied.

Referring to FIG. 1, the motor system may be provided in a vehicle and may include an energy storage device 10, an inverter 20, a motor 30, and a controller 100, but the configuration of the motor system is not limited thereto.

The vehicle may be driven by the motor 30 as a driving source, and the inverter 20 may drive the motor.

For example, the inverter control device to which the inverter junction temperature reduction technique is applied may be usefully applied to control various types of inverters, such as an open-end winding (OEW) inverter/motor system, a multi-phase inverter/motor system, etc.

The motor system may further include a DC link capacitor 40 and a current sensor 50, and may further include additional components for controlling motor operation.

The energy storage device 10 is a component for storing electric energy for driving the motor 30 in the form of DC, such as a battery, and may output DC power.

The inverter 20 may be configured to convert DC power provided from the energy storage device 10 into AC power for driving the motor.

For example, the inverter 20 may include three legs connected in parallel to both ends of the energy storage device 10, and each leg may include a pair of power modules connected in series with each other.

Each of the pair of power modules may be turned on/off by a pulse width modulation (PWM) signal (S: S1 to S6) provided from the controller 100, and may output driving power of one phase (U phase/V phase/W phase).

For example, each power module may include a power semiconductor element and a diode, and the power semiconductor element may be configured as an insulated gate bipolar transistor (IGBT), but is not limited thereto.

A pair of power modules constituting the first leg may form a U-phase power module that outputs a U-phase current, a pair of power modules constituting the second leg may form a V-phase power module that outputs a V-phase current, and a pair of power modules constituting the third leg may form a W-phase power module that outputs a W-phase current.

According to an embodiment, the inverter 20 may provide power supplied from the motor 30 to the energy storage device 10.

The motor 30 is an energy conversion device that generates rotational power based on the three-phase AC power provided from the inverter 20, and various types of motors known in the art may be employed.

For example, the motor 30 may be a permanent magnet synchronous motor (PMSM), but is not limited thereto.

According to an embodiment, a neutral point connection terminal 60 may be connected to a neutral point N to which multiple coils of the motor 30 are commonly connected, and an external device may be connected to the neutral point connection terminal 60.

For example, the external device may receive power output through the neutral point N of the motor 30. For example, the external device may provide power to the neutral point N of the motor 30.

That is, the neutral point connection terminal 60 may output power from the motor system to the external device or may provide power from the external device to the motor system.

The DC link capacitor 40 is connected to both ends of the energy storage device 10 and may generate a DC link voltage Vdc by being charged by the power output from the energy storage device 10. This DC link voltage Vdc may be an input voltage of the inverter 20 and may be input to the controller 100.

The current sensor 50 may be positioned between the inverter 20 and the motor 30, detect the three-phase current provided from the inverter 20 to the motor 30, and output a three-phase current detection value i_ₛₙₛ. This three-phase current detection value i_ₛₙₛ may be provided to the controller 100.

In addition, the motor system may further include a position sensor 70 that detects and outputs the position of the rotor of the motor 30, that is, the rotation angle θ of the rotor of the motor, and a temperature sensor 80 that detects and outputs a junction temperature Temp of the plurality of power modules configured in the inverter 20.

The rotation angle θ detected by the position sensor 70 and the junction temperature Temp detected by the temperature sensor 80 may be input to the controller 100.

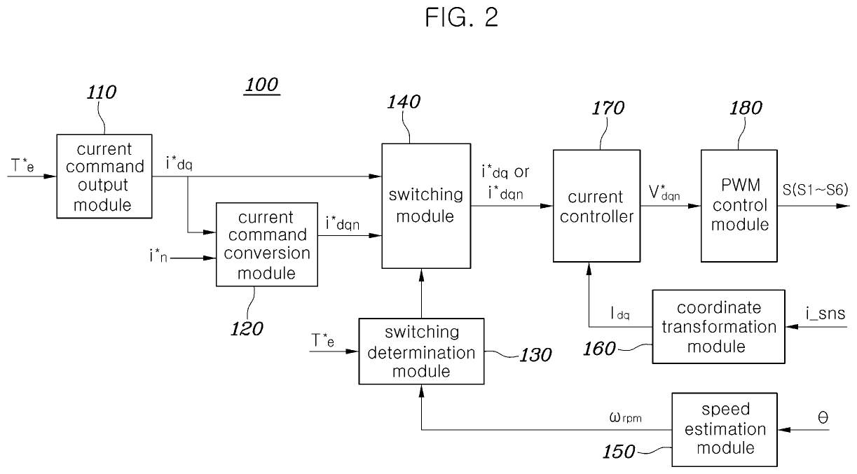

FIG. 2 is a diagram showing a configuration of the controller 100 according to an embodiment of the present disclosure.

Referring to FIG. 2, the controller 100 (or the inverter control device) may perform pulse width modulation (PWM) control to appropriately adjust the duty cycle (duty ratio) of the power modules of the inverter 20 in order to control the torque of the motor 30 to a desired value (torque command) T*ₑ.

According to an embodiment, the controller 100 may perform inverter junction temperature reduction control for alleviating the phenomenon of heat generation being concentrated on a power module of one phase in a hill hold state (including a motor stop state, an extremely low-speed rotation state of the motor, etc.).

The controller 100 may perform control for generating a maximum torque while minimizing a maximum value of phase current by intentionally flowing zero sequence current that is avoided during motor control (hereinafter, referred to as “Maximum Torque Per Degree (MTPD) control”).

According to an embodiment, the controller 100 may include a current command output module 110, a current command conversion module 120, a switching determination module 130, a switching module 140, a speed estimation module 150, a coordinate transformation module 160, a current controller 170, and a PWM control module 180, but the configuration of the controller 100 is not limited thereto.

The current command output module 110 may convert an input torque command T*ₑ into a current command i*_{dq} based on a current map, and output the current command i*_{dq}. For example, the current command i*_{dq} output from the current command output module 110 may be represented as a dq-axis current command.

The current command conversion module 120 may receive the current command i*_{dq} and a zero sequence current command i*ₙ, and convert the phase of the current command i*_{dq} to output a phase-shifted current command i*_{dqn}. Here, the zero sequence current command i*ₙ can be 0 A.

According to the embodiment, the current command conversion module 120 may receive the current command i*_{dq} and the zero sequence current command i*ₙ, perform coordinate axis transformation to generate a phase current command, shift the phase of the phase current command by the average of the maximum phase value and the minimum phase value of the phase current command, and then perform coordinate axis transformation to output the phase-shifted current command i*_{dqn}. For example, the phase-shifted current command i*_{dqn} output from the current command conversion module 120 may be represented as a dqn-axis current command.

The switching determination module 130 may output a control signal to the switching module 140 based on the motor rotation speed ωᵣₚₘ and torque command T*ₑ output from the speed estimation module 150.

To this end, the switching determination module 130 may store a control mode table set according to the motor rotation speed ωᵣₚₘ and torque command T*ₑ.

According to the embodiment, the control mode table may include a first control mode signal for causing the switching module 140 to output the current command i*_{dq} and a second control mode signal for causing the switching module 140 to output the phase-shifted current command i*_{dqn}.

The switching determination module 130 may output a control signal corresponding to a control mode signal to the switching module 140.

For example, a first control signal may be a low-level electrical signal, and a second control signal may be a high-level electrical signal.

The switching module 140 may receive the current command i*_{dq} output from the current command output module 110 and the phase-shifted current command i*_{dqn} output from the current command conversion module 120.

The switching module 140 is controlled by a control signal from the switching determination module 130, and may selectively output one of the current command i*_{dq} and the phase-shifted current command i*_{dqn} based on the control signal.

The speed estimation module 150 may estimate the motor rotation speed ωᵣₚₘ based on the rotation angle θ output from the position sensor 70.

For example, the speed estimation module 150 may include a differentiator and may output the estimated motor rotation speed ωᵣₚₘ to the switching determination module 130. In addition, the speed estimation module 150 may output the estimated motor rotation speed ωᵣₚₘ to the current controller 170.

The coordinate transformation module 160 may receive the three-phase current detection value i_ₛₙₛ detected by the current sensor 50, convert the three-phase current detection value i_ₛₙₛ into a d/q-axis current i_{dqnn}, and output the same to the current controller 170. For example, the coordinate transformation module 160 may be called a synchronous coordinate phase transformation module or a three-phase/dq coordinate transformation module.

The current controller 170 may receive the current command i*_{dq} or the phase-shifted current command i*_{dqn} output from the switching module 140, and generate a phase voltage command (or current control value) v*_{dqn} corresponding to the current command i*_{dq} or the phase-shifted current command i*_{dqn}.

The current controller 170 may output the generated phase voltage command v*_{dqn} to the PWM control module 180.

The current controller 170 may correct the phase voltage command v*_{dqn} based on feedback information to eliminate torque error.

For example, the current controller 170 may receive the d/q-axis current i_{dqnn} from the coordinate transformation module 160. For example, the current controller 170 may receive the motor rotation speed ωᵣₚₘ from the speed estimation module 150.

The PWM control module 180 may modulate the phase voltage command v*_{dqn} output from the current controller 170 according to the PWM method to generate a polar voltage command (S: S1 to S6), which is a PWM signal, and output the same to the inverter 20.

For example, the PWM control module 180 may perform space vector pulse width modulation (SVPWM) to modulate the phase voltage command v*_{dqn} into the polar voltage command (S: S1 to S6), which is a PWM signal, but the modulation method is not limited thereto.

In an embodiment of the present disclosure, the controller 100 may be configured to include a nonvolatile memory configured to store data regarding an algorithm configured to control operations of various components of a vehicle related to the features of the present disclosure or software instructions for reproducing the algorithm, and a processor configured to perform the operations described herein using the data stored in the memory. Here, the memory and the processor may be implemented as separate chips or as a single chip in which the memory and the processor are integrated with each other. In addition, the processor may take the form of one or more processors.

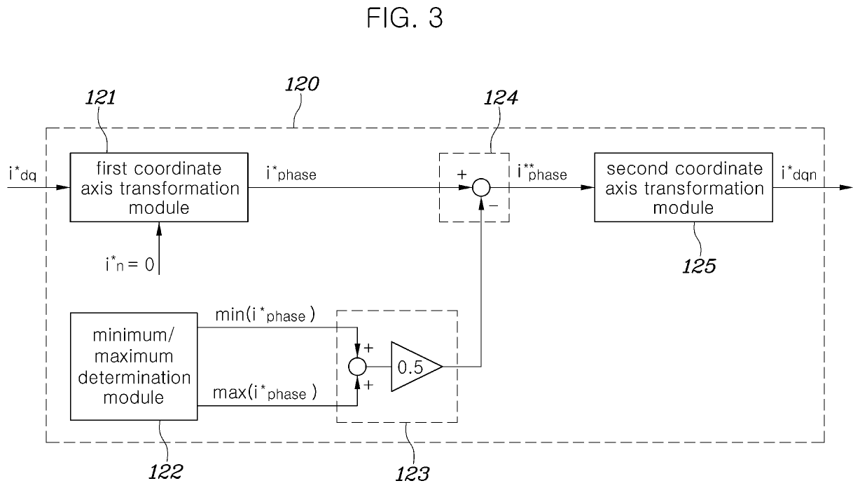

FIG. 3 is a diagram showing a configuration of the current command conversion module 120 according to an embodiment of the present disclosure.

Referring to FIG. 3, the current command conversion module 120 may include a first coordinate axis transformation module 121, a minimum/maximum determination module 122, an average determination module 123, a phase conversion module 124, and a second coordinate axis transformation module 125.

The first coordinate axis transformation module 121 may receive the current command i*_{dq} and the zero sequence current command i*ₙ and perform a coordinate axis transformation to generate a phase current command i* phase.

The minimum/maximum determination module 122 may receive the phase current command i*ₚₕₐₛₑ and determine a minimum phase value min(i*ₚₕₐₛₑ) and a maximum phase value max(i*ₚₕₐₛₑ) based on the phase current command i*ₚₕₐₛₑ.

The average determination module 123 may determine the average of the minimum phase value min(i*ₚₕₐₛₑ) and the maximum phase value max(i*ₚₕₐₛₑ).

The phase conversion module 124 may receive the phase current command i*ₚₕₐₛₑ and the average of the minimum phase value min(i*ₚₕₐₛₑ) and the maximum phase value max(i*ₚₕₐₛₑ) and convert the phase of the phase current command i*ₚₕₐₛₑ based on the average of the minimum phase value min(i*ₚₕₐₛₑ) and the maximum phase value max(i*ₚₕₐₛₑ) to output a phase-shifted phase current command i**ₚₕₐₛₑ.

At this time, the phase conversion module 124 shifts the phase of the phase current command i* phase by the average of the minimum phase value min(i*ₚₕₐₛₑ) and the maximum phase value max(i*ₚₕₐₛₑ) such that the average of the minimum phase value and the maximum phase value of the phase-shifted phase current command i**ₚₕₐₛₑ becomes 0 A.

The second coordinate axis transformation module 125 may receive the phase-shifted phase current command i**ₚₕₐₛₑ and perform coordinate axis transformation to output a phase-shifted current command i*_{dqn}.

According to the embodiment, the current command conversion module 120 may output the phase-shifted current command i*_{dqn} based on the current command i*_{dq} and the zero sequence current command i*ₙ, and the average of the minimum phase value and the maximum phase value of the phase-shifted current command i*_{dqn} can be 0 A.

In the embodiment, the phase-shifted current command i*_{dqn} does not affect the torque because it is the same as the input current command i*_{dq}. In addition, since the average of the minimum phase value and the maximum phase value of the phase-shifted current command i*_{dqn} becomes O A due to the contribution of the zero sequence current i*ₙ, the maximum phase value of the phase-shifted current command i*_{dqn} can be minimized.

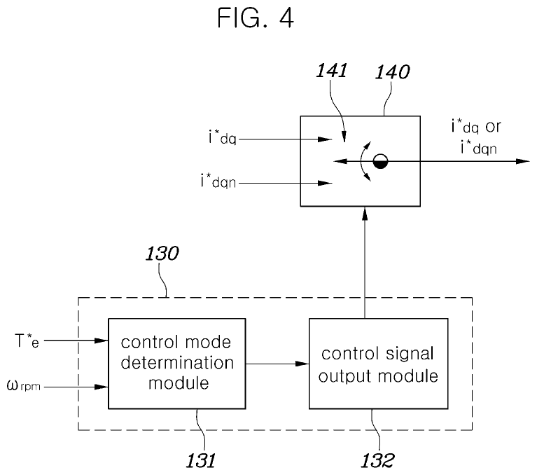

FIG. 4 is a diagram showing a configuration of the switching determination module 130 and the switching module 140 according to an embodiment of the present disclosure.

Referring to FIG. 4, the switching determination module 130 may determine a control mode based on the motor rotation speed ωᵣₚₘ and the torque command T*ₑ, and output a control signal corresponding to the determined control mode to the switching module 140.

According to the embodiment, the switching determination module 130 may include a control mode determination module 131 and a control signal output module 132.

The control mode determination module 131 may determine a control mode based on the motor rotation speed ωᵣₚₘ and the torque command T*ₑ and output a control mode signal corresponding to the determined control mode.

To this end, the control mode determination module 131 may store a control mode table set according to the motor rotation speed ωᵣₚₘ and the torque command T*ₑ.

According to the embodiment, the control mode table may include a first control mode signal for causing the switching module 140 to output the current command i*_{dq} and a second control mode signal for causing the switching module 140 to output the phase-shifted current command i*_{dqn}.

Accordingly, the control mode determination module 131 may output the first control mode signal to cause the switching module 140 to output the current command i*_{dq} and output the second control mode signal to cause the switching module 140 to output the phase-shifted current command i*_{dqn} based on the motor rotation speed ωᵣₚₘ and the torque command T*ₑ.

The control signal output module 132 may receive a control mode signal provided from the control mode determination module 131 and output a control signal corresponding to the control mode signal to the switching module 140.

According to the embodiment, the control signal output module 132 may output a first control signal in response to the first control mode signal and output a second control signal in response to the second control mode signal.

For example, the first control signal may be a low-level electrical signal, and the second control signal may be a high-level electrical signal.

The switching module 140 may selectively output one of the current command i*_{dq} and the phase-shifted current command i*_{dqn} in response to the control signal from the switching determination module 130.

According to the embodiment, the switching module 140 may receive the current command i*_{dq} output from the current command output module 110 and the phase-shifted current command i*_{dqn} output from the current command conversion module 120.

For example, the switching module 140 may output the current command i*_{dq} in response to the first control signal and output the phase-shifted current command i*_{dqn} in response to the second control signal.

The switching module 140 may include a switch 141 that selectively outputs one of the current command i*_{dq} and the phase-shifted current command i*_{dqn} in response to a control signal from the switching determination module 130.

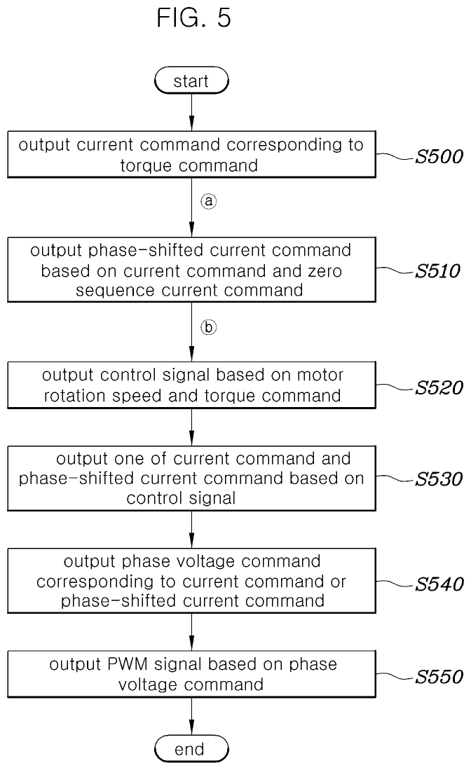

FIG. 5 is a diagram illustrating a method of controlling a motor drive inverter according to an embodiment of the present disclosure.

Hereinafter, the method of controlling a motor drive inverter will be described focusing on the operation of the controller 100 described with reference to FIG. 1 to FIG. 4.

The current command output module 110 may convert an input torque command T*ₑ into a current command i*_{dq} based on a current map and output the current command i*_{dq} (S500).

The current command conversion module 120 may receive the current command i*_{dq} and a zero sequence current command i*ₙ, phase-shift the current command i*_{dq}, and output a phase-shifted current command i*_{dqn} (S510).

The switching determination module 130 may output a control signal to the switching module 140 based on the input motor rotation speed ωᵣₚₘ and torque command T*ₑ (S520).

Thereafter, the switching module 140 may output one of the current command i*_{dq} and the phase-shifted current command i*_{dqn} based on the control signal (S530).

The current controller 170 may output a phase voltage command (or current control value) v*_{dqn} corresponding to the current command i*_{dq} or the phase-shifted current command i*_{dqn} (S540).

The PWM control module 180 may modulate the phase voltage command v*_{dqn} according to a PWM method to generate a polar voltage command (S: S1 to S6), which is a PWM signal, and output the same to the inverter 20 (S550).

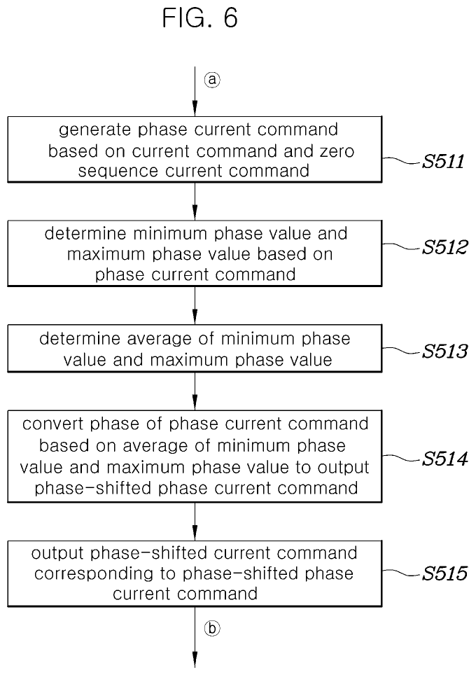

FIG. 6 is a diagram specifically illustrating step S510 of FIG. 5.

Referring to FIG. 6, the current command conversion module 120 may generate a phase current command i*ₚₕₐₛₑ based on the current command i*_{dq} and the zero sequence current command i*ₙ (S511).

The current command conversion module 120 may determine a minimum phase value min(i*ₚₕₐₛₑ) and a maximum phase value max(i*ₚₕₐₛₑ) based on the phase current command i*ₚₕₐₛₑ (S512) and determine the average of the minimum phase value min(i*ₚₕₐₛₑ) and the maximum phase value max(i*ₚₕₐₛₑ) (S513).

Thereafter, the current command conversion module 120 may shift the phase of the phase current command i*ₚₕₐₛₑ based on the average of the minimum phase value min(i*ₚₕₐₛₑ) and the maximum phase value max(i*ₚₕₐₛₑ) to output a phase-shifted phase current command i**ₚₕₐₛₑ (S514).

In step S514, the current command conversion module 120 may shift the phase of the phase current command i*ₚₕₐₛₑ by the average of the minimum phase value min(i*ₚₕₐₛₑ) and the maximum phase value max(i*ₚₕₐₛₑ) such that the average of the minimum phase value and the maximum phase value of the phase-shifted phase current command i**ₚₕₐₛₑ becomes 0 A.

Thereafter, the current command conversion module 120 may output the phase-shifted current command i*_{dqn} corresponding to the phase-shifted phase current command i**ₚₕₐₛₑ (S515).

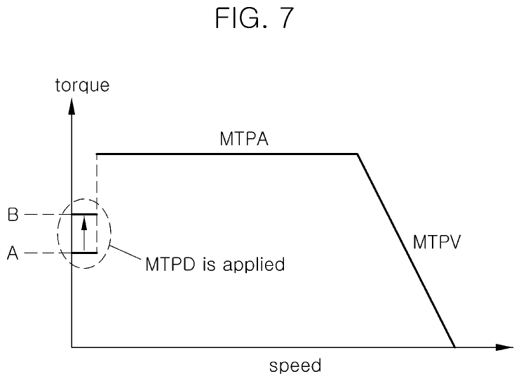

FIG. 7 is a graph for explaining a limit torque depending on whether or not the MTPD control technique according to an embodiment of the present disclosure is applied.

In FIG. 7, A represents a limit torque value when the MTPD control technique according to an embodiment of the present disclosure is not applied, and B represents a limit torque value when the MTPD control technique according to an embodiment of the present disclosure is applied.

The MTPD control technique according to an embodiment of the present disclosure can alleviate the phenomenon of heat generation being concentrated in a power module of one phase.

Although the value of the limit torque is low due to the phenomenon of heat generation concentration in the case of the conventional technique (A in FIG. 7), when the TMPD control technique according to an embodiment of the present disclosure is applied, the phenomenon of heat generation being concentrated in a power module of one phase can be alleviated, and therefore, the value of the limit torque can be increased (B in FIG. 7).

According to an embodiment of the present disclosure, it is possible to provide an inverter junction temperature reduction technique capable of alleviating the phenomenon of heat generation being concentrated in a power module of one phase in a hill hold state (including a motor stop state, an extremely low-speed rotation state of the motor, etc.).

Furthermore, it is possible to provide a Maximum Torque Per Degree (MTPD) control technique capable of generating maximum torque while intentionally flowing a zero sequence current that is avoided during motor control to minimize a maximum value of a phase current.

Since the inverter junction temperature reduction technique according to an embodiment of the present disclosure can reduce the junction temperature of the power module by minimizing the magnitude of the phase current flowing through the inverter, it is possible to lower the junction temperature compared to the MTPA technique at the same torque, and ultimately, a reduction in hardware costs is anticipated.

In addition, it can be expected to reduce the cost of the power module, and it can be expected to simplify a power module cooling system, and thus the weight of the cooling system can be reduced and the cost can be reduced.

The MTPD control technique according to an embodiment of the present disclosure can be usefully applied to control various types of inverters, such as an open-end winding (OEW) inverter/motor system, a multi-phase inverter/motor system, etc.

The effects of the present disclosure are not limited to the effects mentioned above, and other effects not mentioned can be clearly understood by those skilled in the art from the description below.

The contents of the problems to be solved, the means for solving the problems, and the effects mentioned above do not specify the essential features of the claims, and thus the scope of the rights of the claims is not limited by the matters described in the contents of the disclosure.

Although the embodiments of the present disclosure have been described in more detail with reference to the attached drawings, the present disclosure is not necessarily limited to these embodiments, and various modifications may be made without departing from the technical idea of the present disclosure. Accordingly, the embodiments disclosed in this specification are not intended to limit the technical idea of the present disclosure, but to explain the same, and the scope of the technical idea of the present disclosure is not limited by such embodiments. Therefore, it should be understood that the embodiments described above are exemplary in all aspects and not restrictive. The scope of the present disclosure should be interpreted by the claims, and all technical ideas within a scope equivalent thereto should be interpreted as being included in the scope of the rights of the present disclosure.

What is claimed is:

1. An inverter control device, comprising:
a current command output module configured to output a current command corresponding to an input torque command;
a current command conversion module configured to receive the current command and a zero sequence current command, and to phase-shift the current command to output a phase-shifted current command;
a switching determination module configured to output a control signal based on an input motor rotation speed and the input torque command; and
a switching module configured to output one of the current command and the phase-shifted current command in response to the control signal.

2. The inverter control device of claim 1, wherein an average of a minimum phase value and a maximum phase value of the phase-shifted current command is 0 A.

3. The inverter control device of claim 1, wherein the current command conversion module is further configured to:
generate a phase current command based on the current command and the zero sequence current command; and
shift a phase of the phase current command by an average of a maximum phase value and a minimum phase value of the phase current command to generate a phase-shifted phase current command.

4. The inverter control device of claim 3, wherein the current command conversion module is further configured to perform coordinate axis transformation on the phase-shifted phase current command to output the phase-shifted current command.

5. The inverter control device of claim 1, wherein the current command conversion module comprises:
a first coordinate axis transformation module configured to generate a phase current command based on the current command and the zero sequence current command;
a minimum and maximum determination module configured to determine a minimum phase value and a maximum phase value based on the phase current command;
an average determination module configured to determine an average of the minimum phase value and the maximum phase value; and
a phase conversion module configured to convert a phase of the phase current command based on the average of the minimum phase value and the maximum phase value to generate a phase-shifted phase current command.

6. The inverter control device of claim 5, wherein the phase conversion module is configured to shift the phase of the phase current command by the average of the minimum phase value and the maximum phase value.

7. The inverter control device of claim 5, wherein the average of the minimum phase value and the maximum phase value of the phase-shifted phase current command is 0 A.

8. The inverter control device of claim 1, wherein the switching determination module comprises:
a control mode determination module configured to determine a control mode based on the motor rotation speed and the torque command and output a control mode signal corresponding to the determined control mode; and
a control signal output module configured to output the control signal in response to the control mode signal.

9. The inverter control device of claim 8, wherein the control mode determination module includes a control mode table including a first control mode signal or a second control mode signal set according to the motor rotation speed and the torque command.

10. The inverter control device of claim 9, wherein the control mode determination module is configured to output the first control mode signal to cause the switching module to output the current command, and output the second control mode signal to cause the switching module to output the phase-shifted current command.

11. An inverter control method, comprising:
outputting a current command corresponding to an input torque command;
phase-shifting the current command based on the current command and a zero sequence current command to output a phase-shifted current command;
outputting a control signal based on a motor rotation speed and the torque command; and
outputting one of the current command and the phase-shifted current command in response to the control signal.

12. The inverter control method of claim 11, further comprising:
outputting a phase voltage command corresponding to the current command or the phase-shifted current command; and
modulating the phase voltage command to output a pulse width modulation (PWM) signal to an inverter.

13. The inverter control method of claim 11, wherein the outputting the phase-shifted current command comprises:
generating a phase current command based on the current command and the zero sequence current command;
determining a minimum phase value and a maximum phase value based on the phase current command;
determining an average of the minimum phase value and the maximum phase value; and
generating a phase-shifted phase current command by converting a phase of the phase current command based on the average of the minimum phase value and the maximum phase value.

14. The inverter control method of claim 13, wherein converting the phase of the phase current command comprises shifting the phase of the phase current command by the average of the minimum phase value and the maximum phase value.

15. The inverter control method of claim 13, wherein the average of the minimum phase value and the maximum phase value of the phase-shifted phase current command is 0 A.

16. The inverter control method of claim 13, wherein the outputting the phase-shifted current command comprises performing coordinate axis transformation on the phase-shifted phase current command and outputting the phase-shifted current command.

17. The inverter control method of claim 11, wherein the outputting a control signal comprises:
determining a control mode based on the motor rotation speed and the input torque command;
outputting a control mode signal corresponding to the control mode; and
outputting the control signal in response to the control mode signal.

18. The inverter control method of claim 11, wherein the outputting a control signal comprises outputting a first control mode signal to cause a switching module to output the current command, and outputting a second control mode signal to cause the switching module to output the phase-shifted current command.

19. A vehicle including a motor as a driving source, the vehicle comprising:
an inverter configured to drive the motor; and
a device for controlling the inverter, wherein the device is configured to:
generate a current command corresponding to a torque command;
receive the current command and a zero sequence current command;
phase-shift the current command to generate a phase-shifted current command; and
output one of the current command and the phase-shifted current command based on a motor rotation speed and the torque command.

20. The vehicle of claim 19, wherein the device is further configured to:
output a phase voltage command corresponding to the current command or the phase-shifted current command; and
modulate the phase voltage command to output a pulse width modulation (PWM) signal to the inverter.
